(19) United States
(12) Patent Application Publication
(10) Pub. No.: US 2014/0152649 A1
(43) Pub. Date: Jun. 5, 2014

(54) Inspector Tool for Viewing 3D Images

(71) Applicant: Thomas Moeller, Nuernberg (DE)

(72) Inventor: Thomas Moeller, Nuernberg (DE)

(21) Appl. No.: 13/692,639

(22) Filed: Dec. 3, 2012

(51) Int. Cl. G06T 19/00

(52) U.S. Cl. CPC G06T 19/00
USPC 345/419

(57) ABSTRACT

In order to decrease the amount of time required to localize a structure of interest and generate a diagnostic image, a target point is identified within a volume represented by a 3D dataset. The target point is based on a first user input. The 3D dataset is scaled around the identified target point to identify a volume of interest within the 3D dataset, where the scale is based on one or more second user inputs. The 3D dataset is automatically cropped to the volume of interest based on the scaling, and a representation of the cropped 3D dataset is displayed.

### FIELD

The present embodiments relate to the viewing and exploring of three-dimensional datasets.

### BACKGROUND

A medical imaging device (e.g., a computed tomography (CT) device, a magnetic resonance (MR) device, an ultrasound device, or a three-dimensional (3D) rotational angiography device) may be used to generate a 3D dataset representing, for example, at least a portion of a body of a patient including a structure of interest. The 3D dataset may be further processed to generate a 3D image and one or more two-dimensional (2D) cross-sectional images of the portion of the body. The 3D image and/or the one or more 2D images may be displayed at a medical imaging workstation (e.g., a computing device).

A user of the medical imaging workstation may use one or more viewing applications to localize the structure of interest and diagnose a disease represented within the 3D dataset. Numerous tools of the viewing applications are provided to the user for 2D or 3D viewing. The separate tools allow the user to reposition, scale and rotate the image. Clipping tools of the viewing applications such as, for example, clip planes and crop boxes allow the user to remove obstructing structures.

Applying the tools of the viewing applications to localize the structure of interest (e.g., using the clipping tools) and generating a diagnostic image may be time consuming. The user may be required to learn how to use a large number of separate tools to obtain an unobstructed view of the structure of interest.

### SUMMARY

In order to decrease the amount of time required to localize a structure of interest and generate a diagnostic image, a target point is identified within a volume represented by a 3D dataset. The target point is based on a first user input. The 3D dataset is scaled around the identified target point to identify a volume of interest within the 3D dataset, where the scale is based on one or more second user inputs. The 3D dataset is automatically cropped to the volume of interest based on the scaling, and a representation of the cropped 3D dataset is displayed.

In one aspect, a method for visualizing a volume of interest within a 3D dataset is provided. The method includes identifying a target point within a volume represented by the 3D dataset. The 3D dataset is scaled around the identified target point, such that the volume of interest is identified. A processor automatically crops the 3D dataset to the volume of interest based on the scaling, and a representation of the cropped 3D dataset is displayed.

In another aspect, a system for visualizing a region of interest within a dataset is provided. The system includes an input operable to receive a first input, a second input, and a third input from a user input device. The system also includes a processor operatively connected to the input. The processor is configured to identify a target point within a volume represented by the dataset based on the first input. The processor is also configured to scale the dataset around the identified target point based on the second input and the third input, such that the region of interest is identified. The processor is configured to crop the dataset to the region of interest based on the scaling.

In yet another aspect, instructions executable by one or more processors to visualize a volume of interest within a 3D dataset are stored in a non-transitory computer-readable storage medium. The instructions include displaying a representation of at least a portion of the 3D dataset. The representation of at least the portion of the 3D dataset includes at least one 2D image, a 3D image, or the at least one 2D image and the 3D image. The instructions include identifying a target point relative to the representation based on an input from a user input device. The input includes a selected point within the displayed representation of at least the portion of the 3D dataset. The instructions also include scaling around the identified target point, such that the volume of interest is identified, cropping the 3D dataset to the volume of interest based on the scaling, and displaying a representation of the cropped 3D dataset.

### BRIEF DESCRIPTION OF THE DRAWINGS

FIG. 1 shows one embodiment of a medical imaging system;

FIG. 2 shows a flowchart of one embodiment of a method for visualizing a volume of interest within a three-dimensional (3D) dataset;

FIG. 3 shows exemplary images representing a 3D dataset; and

FIG. 4 shows exemplary images representing a cropped 3D dataset.

### DETAILED DESCRIPTION OF THE DRAWINGS

The individual image manipulation tools of the prior art are replaced by a single three-dimensional (3D) image review mode utilizing an inspector tool. The inspector tool integrates a number of functions to localize, crop, and enlarge structures of interest. The inspector tool also links all cross-sectional views and 3D projection views. Each of the cross-sectional views and the 3D projection views shows the same structure of interest, allowing a user to work in a single view and still obtain images of that same structure of interest in different views (e.g., showing different orientation or visualization type). Less than all of the views may be linked in other embodiments.

For example, after loading or reconstructing a 3D dataset representing at least a portion of a body of a patient, the 3D dataset is processed to generate a 3D image and one or more two-dimensional (2D) images. The 3D image and/or the one or more 2D images are displayed at a computing device. The user may interact with the 3D image and/or the one or more 2D images in a default interaction mode. For the 3D image, the default interaction mode may be changing the viewing angle, while for the one or more 2D images, the default interaction mode may be changing a slice position relative to the volume.

To focus on the structure of interest (e.g., a region of interest) within the volume represented by the 3D dataset, the user may activate the inspector tool and select a target point within a displayed image (e.g., the 3D image or a 2D image of the one or more 2D images). The user may select the target point using a user input device of the computing device such as, for example, a joystick (e.g., by pressing a button of the joystick). The target point becomes a focal point for all views (e.g., including the 3D image and the one or more 2D images). The user may then scale the displayed image around the focal point. For example, the user may adjust a zoom factor (e.g., image scale) and set the zoom factor for the displayed image using the user input device (e.g., by moving the joystick forward and backward and pressing a button of the joystick, respectively).

The displayed, zoomed image defines a volume of interest. A resulting image height of the zoomed image is applied to all three dimensions of the volume of interest (e.g., the length, width, and height of the volume of interest is equal to the resulting image height). The image height of the zoomed image corresponds to a distance within the volume represented by the data. The volume of interest is then segmented automatically from the 3D dataset. The data of the 3D dataset representing locations outside of the volume of interest is cropped. The amount of zoom determines the amount of the volume cropped. In other words, data representing structures lying outside the volume of interest are removed from the 3D dataset. The cropped volume of interest is then displayed to the user. The process of adjusting the image scale may be repeated until the user is satisfied with the results.

The cropped volume of interest becomes the 3D dataset that is being reviewed and processed. The center of the volume of interest is used as the focal point and also defines a rotational axis for further image rotation operations in the image review mode. The views are synchronized and aligned to the cropped volume of interest. Automatic post-processing operations may optionally also be performed. For example, the cropped volume of interest may be reconstructed in higher resolution, which improves image quality.

By replacing a complex set of 3D image review functions with a simple review workflow including a single review mode and an inspector tool, the user may obtain diagnostic images much faster. Through the reduction of total acts and by simplifying the type of interaction to obtain diagnostic images, 3D image review may also be made accessible during interventional procedures. Unlike in radiology, where images may be reviewed long after acquisition by users working on workstations, the user views images in interventional suites and operating rooms during interventional procedures, while the patient is still on the table.

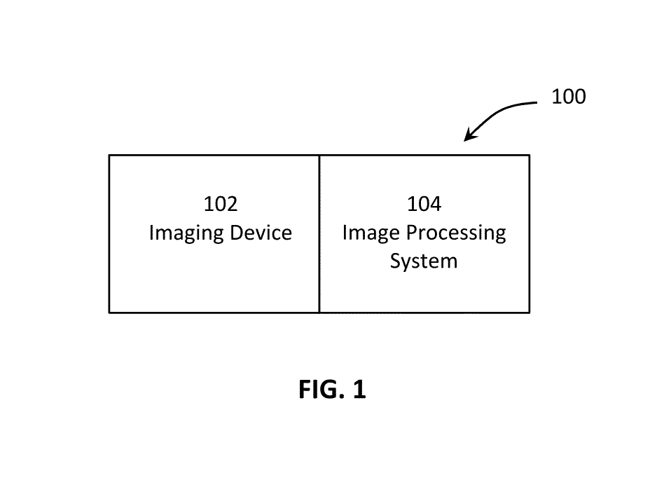

FIG. 1 shows one embodiment of an imaging system 100 (e.g., a medical imaging system). The medical imaging system 100 may be used in the method described below or other methods. The medical imaging system 100 may include one or more imaging devices 102 and one or more image processing systems 104. Additional, different or fewer components may be provided. For example, a user input device (e.g., keyboard, mouse, trackball, touch pad, touch screen, buttons, or knobs) is provided. The image processing system 104 is part of the medical imaging system 100, but may be a separate computer or workstation in other embodiments.

One or more datasets representing a two-dimensional (2D) or a three-dimensional (3D) (e.g., volumetric) region may be acquired using the imaging device 102 and the image processing system 104. The 2D dataset or the 3D dataset may be obtained contemporaneously with the planning and/or execution of a medical treatment procedure or at an earlier time. The medical imaging system 100 may be used to create a patient model that may be used in the planning of a medical treatment procedure and/or may be used to diagnose a malformation (e.g., a tumor) or a disease.

In one embodiment, the imaging device 102 is, for example, a magnetic resonance imaging (MRI) device. In other embodiments, the imaging device 102 may be a computed tomography (CT) device, a three-dimensional (3D) rotational angiography device (e.g., DynaCT), an ultrasound device (e.g., a 3D ultrasound imaging device), a positron emission tomography (PET) device, an angiography device, a fluoroscopy device, an x-ray device, a single photon emission computed tomography (SPECT) device, any other now known or later developed imaging device, or a combination thereof.

The image processing system 104 may, for example, be a computing device within or in proximity to an interventional suite or an operating room, in which the imaging device 102 and/or a patient is located. Alternatively, the image processing system 104 may be a medical workstation that is remote from the interventional suite or the operating room. The image processing system 104 receives data representing or images of the patient generated by the imaging device 102.

The image processing system 104 may include, for example, a processor, a memory, a display, a user input device, any other computing devices, or a combination thereof. The processor is a general processor, a central processing unit, a control processor, a graphics processor, a digital signal processor, a three-dimensional rendering processor, an image processor, an application-specific integrated circuit, a field-programmable gate array, a digital circuit, an analog circuit, combinations thereof, or other now known or later developed device for image processing. The processor is a single device or multiple devices operating in serial, parallel, or separately. The processor may be a main processor of a computer, such as a laptop or desktop computer, or may be a processor for handling some tasks in a larger system, such as being part of the imaging device 102 or the image processing system 104. The processor is configured by instructions, design, hardware, and/or software to perform the acts discussed herein, such as controlling the viewing of a 3D image dataset. The processor provides interaction by the user for selecting portions of the volume and corresponding data to be used for generating 3D and/or 2D images.

The memory is computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory may be a single device or a combination of devices. The memory may be adjacent to, part of, networked with and/or remote from the processor.

The display is a monitor, a CRT, an LCD, a plasma screen, a flat panel, a projector or other now known or later developed display device. The display is operable to generate images for a two-dimensional view or a rendered three-dimensional representation. For example, a two-dimensional image representing a three-dimensional volume through rendering is displayed.

The user input device is a moveable joystick including one or more depressible buttons, a touchpad, a mouse, a keyboard, any other now know or later developed user input devices, or a combination thereof. In one embodiment, the joystick is attached to a patient table disposed in proximity to the imaging device 102, for example. In another embodiment, the user input device may be incorporated into the display in that the display is a touch screen. The user input device may be located inside or outside the interventional suite or the operating room.

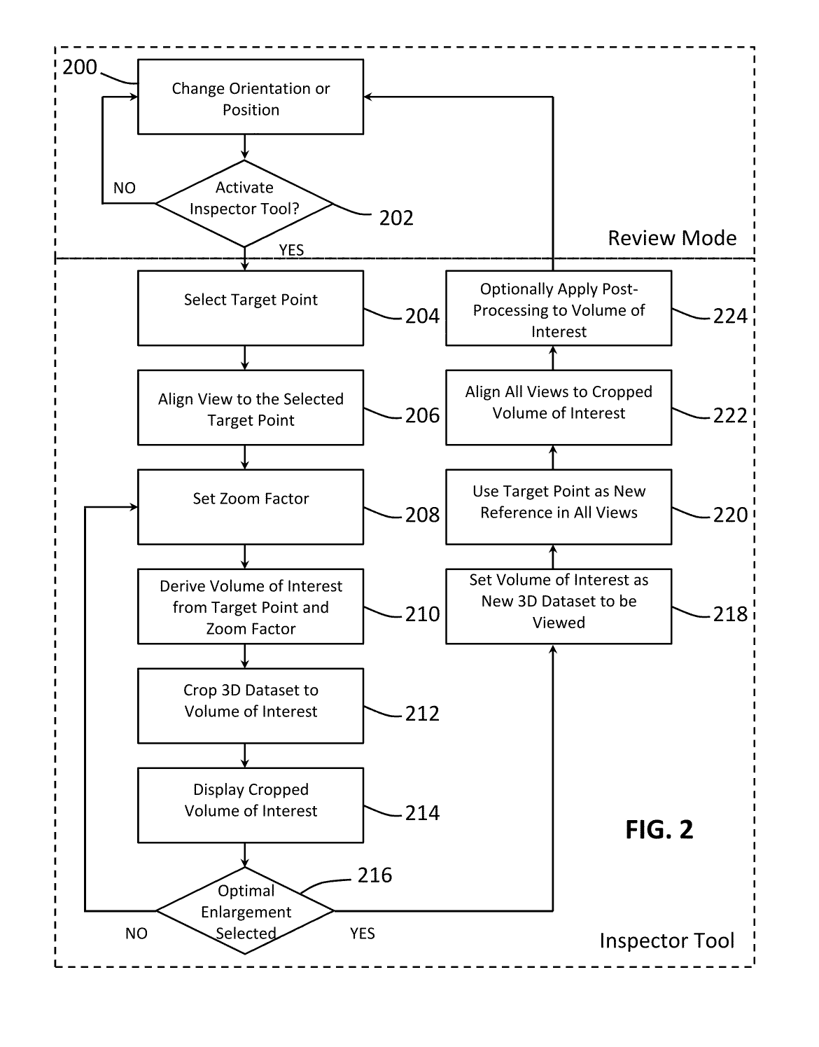

FIG. 2 shows a flowchart of one embodiment of a method for visualizing a volume of interest within a 3D dataset. The method may be performed using the medical imaging system 100 shown in FIG. 1 or another medical imaging system. The method is implemented in the order shown, but other orders may be used. Additional, different, or fewer acts may be provided. Similar methods may be used for visualizing a region of interest within a 3D dataset.

In one embodiment, a workstation in communication with a medical imaging device (e.g., an MRI device or a 3D angiographic acquisition system) is used to visualize a volume represented by 3D data. A user may be able to interact with the medical imaging device using a user input device, for example. The user input device may be any number of user input devices including, for example, a movable joystick including at least one depressible button. Other user input devices such as, for example, a touchpad, a mouse and/or a keyboard may be provided.

The 3D data may be generated (e.g., reconstructed) by the medical imaging device and stored in a memory of the workstation or another memory, for example. A processor of the workstation or another processor may further process (e.g., reconstruct) the 3D data to generate one or more 2D images (e.g., a multi-planar reconstruction) and/or a 3D image that represents the 3D data. The user may select the stored 3D data for display at the workstation using the user input device, for example. For example, three 2D images and the 3D image may be displayed at the workstation in any number of orientations (e.g., a quad display with the 3D image in the bottom-right, and the three 2D images in the top-left, the top-right, and the bottom-left). In one embodiment, the 3D data may be used to automatically display images at the workstation after the 3D data is generated by the medical imaging device.

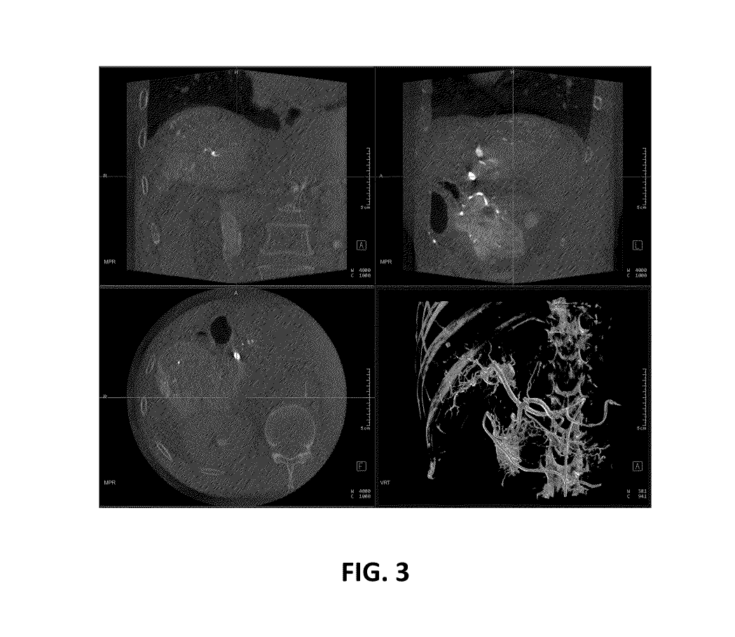

FIG. 3 shows an exemplary display (e.g., within a graphical user interface (GUI) at the workstation) of images from a 3D dataset representing at least a part of a liver of a patient obtained with 3D rotational angiography. The bottom-right of the display shows a 3D image of the liver, and the top-left, top-right, and bottom-left of the display show 2D images (e.g., 2D slices or cross-section planes) of the liver. The 2D slices of the liver may be from different directions relative to the liver. For example, the 2D slices may include one or more sagittal views, one or more axial views, and/or one or more coronal views.

After loading the 3D data, a review mode at the workstation may be initiated. In act 200, an orientation or position within the 3D data may be changed. The processor may initiate and execute the review mode at the workstation based on inputs received from the user input device (e.g., deflection of the joystick and the pressing of the depressible button of the joystick). For example, a cursor may be displayed at the workstation, and the user may control the cursor using the moveable joystick. The user may, for example, move the cursor over one of the three 2D images or over the 3D image using the joystick and press the depressible button of the joystick to enter the review mode. Alternatively, the user does not have to press the depressible button of the joystick to enter the review mode. Instead, by deflecting the joystick to the left and/or the right, the user may cycle through and highlight one of the three 2D images and the 3D image, and the user may enter the review mode within the highlighted image by deflecting the joystick forward and backward. Other user inputs may be used to select one of the three 2D images and the 3D image and/or to enter the review mode.

With a 2D image selected within the review mode, the user may scroll through the 3D data in one direction by deflecting the joystick forward and backward. For example, based on a backward deflection, the processor may change the selected 2D image (e.g., a coronal slice) displayed at the workstation to a 2D image formed from data representing a greater depth into the body of the patient, and based on a forward deflection, the processor may change the selected 2D image displayed at the workstation to a 2D image formed from data representing a lesser depth into the body of the patient. Changing the slice position may be a default interaction mode if a 2D image is selected within the review mode at the workstation. Other default interaction modes may include, for example, changing a viewing angle. With the 3D image selected within the review mode, the processor may change the viewing angle relative to the volume for generating the 3D image based on a deflection of the joystick in any direction. Other user interactions with the joystick and other user input devices (e.g., a mouse or a touchpad) may be used to enter the review mode (e.g. a mouse click) and/or change the viewing angle of the volume represented by the 3D data within the review mode (e.g., mouse movements and/or finger movements at the touchpad).

In act 202, the processor may activate an inspector tool based on an input from the user input device. In one embodiment, the user may press the depressible button of the joystick while a cursor controlled by the joystick is anywhere on the display of the workstation to activate the inspector tool. In other embodiments, the user selects an icon, an item from a menu, or otherwise indicates selection of the inspector tool. The processor causes display of an icon to the user in response to the input from the user input device. For example, a user determines whether or not to activate the inspector tool at the workstation. If the user is satisfied with the slice position of the 2D image or the viewing angle relative to the 3D image, the user may activate the inspector tool by, for example, pressing the depressible button of the joystick. In one embodiment, the icon may be a cross-hair. Other icons may be displayed at the workstation to indicate that the inspector tool is activated.

If the user is not satisfied with the slice position of the 2D image or the viewing angle relative to the volume, the user may continue to change the slice position or the viewing angle relative to the volume, respectively, by deflecting the joystick. Other user interactions with the joystick (e.g., pressing a different depressible button than used in the review mode) and other user input devices (e.g., a mouse) may be used to activate the inspector tool (e.g. a mouse click).

In act 204, a target point is selected. The processor may set the target point within the 3D data based on one or more inputs from the user input device (e.g., a location of the cross-hair on the selected image, at which the user pressed the depressible button). For example, the user may position the cross-hair onto a structure of interest within the selected image by deflecting the joystick in any number of different directions. The user may identify the target point (e.g., a three-dimensional target point) by, for example, pressing the depressible button once the cross-hair is positioned on the structure of interest to be further explored. The processor may, for example, determine the three-dimensional target point by casting a ray at the location of the cross-hair on the selected image along a current viewing direction. An intersection of the ray with structure visible in the view (e.g., intersection of the ray with a surface closest to the viewer) provides a third dimension for a location of the target point within the 3D data (e.g., coordinates of the target point within the 3D data). The target point may be selected and/or determined in other ways, such as a processor identifying a location by data or image processing.

In act 206, the selected image (e.g., a selected view) is aligned to the target point selected in act 204 (e.g., the selected image is shifted to center the target point at the display of the workstation). For example, the processor sets the selected target point as a focal point for the selected image. The focal point may, for example, define a center of a volume of interest, about which the selected image is scaled. The selected target point may be set as the focal point for the other 2D images of the three 2D images (e.g., other views displayed at the workstation) and the 3D image displayed at the workstation. In one embodiment, the selected target point is set as the focal point for any 2D images of the plurality of 2D images to be displayed at the workstation.

In act 208, a zoom factor is set. The processor may scale the selected image around the focal point and set the scale of the selected image based on inputs from the user input device. For example, the user may deflect the joystick forward and backward to increase the zoom factor and decrease the zoom factor for the selected image, respectively. With increasing zoom factor, the structure of interest, for example, may increase in displayed size and may be better visualized at the workstation. Once the user is satisfied with the scale of the selected image, the user may press the depressible button of the joystick to set the zoom factor. In other embodiments, different inputs from the joystick may adjust the zoom factor and/or set the zoom factor (e.g., backward deflection increases the zoom factor, and forward deflection decreases the zoom factor; left deflection increases the zoom factor, and right deflection decreases the zoom factor; or pressing of a different depressible button of the joystick than pressed to activate the inspector tool to set the zoom factor), or different user input devices may be used to adjust and/or set the zoom factor (e.g., a rotation of a wheel of a mouse adjusts the zoom factor, and a click of the mouse sets the zoom factor).

With the selection of the target point in act 204, the cross-hair displayed at the workstation may be with replaced with, for example, a zoom symbol to indicate to the user that the selected image may be scaled. Other icons may be displayed at the workstation to indicate that the selected image may be scaled.

In act 210, a volume of interest may be derived (e.g., identified or defined) based on the target point selected in act 204 and the zoom factor set in act 208. The processor may determine an image height of the selected image after the zoom factor has been set. In one embodiment, the processor may determine the image height by dividing the height of the selected image, pre-zoom, by the square root of the set zoom factor. A linear mapping of zoom factor to image size or other calculation methods may also be used to determine the image height. The height of the selected image, pre-zoom, may be based on the 3D data (e.g., dimensions associated with each voxel in the 3D data) and/or may correspond to a dimension in the body of the patient. In one embodiment, the selected image itself and, accordingly, the image height, as stored in the memory, may be characterized by a number of pixels. For example, each 2D dataset of the plurality of 2D datasets generated by the medical imaging device and, accordingly, each 2D image of the plurality of 2D images may represent a square foot within the body of the patient. If the zoom factor is set to be two, and the target point is selected to be a center point of the selected image, the image height of the scaled selected image may represent approximately 0.71 feet within the body of the patient. In other embodiments, the processor may determine an image width, diagonal or other measure of the selected image after the zoom factor has been set in addition or alternatively to the image height. The image height represents a certain, quantifiable portion of the volume of the patient. Zooming changes the size of the portion represented.

The processor may use the determined image height to define the volume of interest. For example, the processor may automatically set the width and the depth of the volume of interest to be equal to the determined image height. In other words, the volume of interest may be defined as representing a cube within the 3D dataset (e.g., representing a cube within the body of the patient) having lengths equal to the determined image height. In other embodiments, the width of the volume of interest may be set to be equal to the image width optionally determined, and/or the depth of the volume of interest may be a constant value preset by the user (e.g., regardless of the image height calculated by the processor). Any function relating the measures may be used, such as maintaining a predetermined aspect ratio. Alternatively, the different dimensions may be set separately, such as through repetition of selection from different viewing directions.

In act 212, the 3D data may be cropped to the volume of interest derived in act 210. The processor may automatically crop the 3D data to the volume of interest. In one embodiment, the processor may not crop the 3D data to the volume of interest until an input is received from the user input device (e.g., the pressing of the depressible button of the joystick). For example, the processor may display a text box at the workstation requesting the user verify that the 3D data is to be cropped by pressing the depressible button of the joystick. Data of the 3D data outside the volume of interest may be deleted from the 3D data, or the 3D data representing the volume of interest is segmented. In one embodiment, the processor may save a copy of the 3D data before cropping the 3D data to the volume of interest.

In act 214, the processor may display a representation of the cropped 3D data (e.g., the volume of interest; the cropped image) at the workstation. The cropped image may be displayed in a same window as the selected image at the workstation. In other words, the cropped image may be the same size as the selected image but at a larger scale. In one embodiment, the cropped image may be displayed in an area of the display of the workstation originally including the three 2D images and the 3D image (e.g., see FIG. 3).

In act 216, the processor may exit (e.g., deactivate) the inspector tool and set the volume of interest if one input is received from the user input device. For example, a user determines whether or not an optimal enlargement is selected (e.g., the set zoom factor sufficiently defines/shows the structure of interest). If the user is satisfied with the selected enlargement (e.g., the zoom factor), the user may deactivate the inspector tool by, for example, pressing the depressible button of the joystick or by deflecting the joystick to the left or to the right to start image rotation or cycle trough the plurality of 2D images. Other inputs of the user input device may deactivate the inspector tool, or other user input devices may be used to deactivate the inspector tool.

The processor may keep the inspector tool activated if another input is received from the user input device (e.g., the pressing of another depressible button of the joystick or the vertical deflection of the joystick). If the user is not satisfied with the selected enlargement, the user may continue to change the zoom factor by, for example, deflecting the joystick up or down to zoom in or zoom out, respectively.

In act 218, the processor sets the cropped 3D data (e.g., the volume of interest) as new 3D data to be viewed and processed. The processor may set the cropped 3D data as the new 3D data once the inspector tool is deactivated. In one embodiment, the processor may replace the original 3D data with the cropped 3D data in the memory. The processor may generate and display a prompt (e.g., textual data) at the workstation requesting the user verify that the original 3D data is to be replaced. Alternatively, the processor may automatically replace the original 3D data with the cropped 3D data in the memory once the inspector tool is deactivated. In another embodiment, the processor may save the cropped 3D data in the memory separately from the original 3D data.

In act 220, the processor sets the target point selected in act 204 as a new reference (e.g., a new focal point) for all views (e.g., 2D images of the plurality of 2D images with corresponding slice positions remaining in the cropped 3D data, and the 3D image). For example, the processor may set the center of the volume of interest to be the new focal point for all the views. The new focal point may define a rotational axis for further image rotation operations in the review mode. In one embodiment, the user may select the new focal point using the user input device. Focal points other than the center of the volume of interest may be selected and set by the processor.

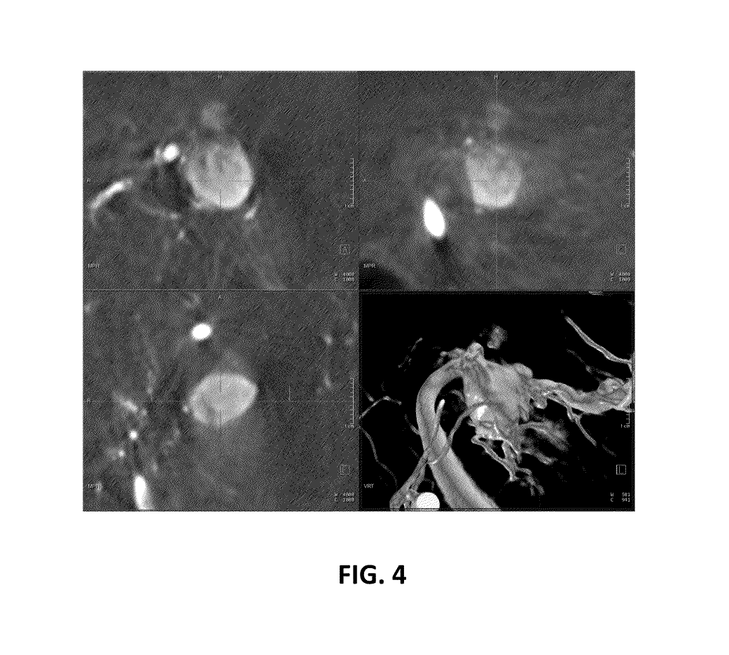

In act 222, the processor aligns the views to the cropped volume of interest. For example, the processor may synchronize and align all the views displayed at the workstation (e.g., the three cropped 2D images and the cropped 3D image). FIG. 4 shows an exemplary display (e.g., within the GUI at the workstation) of representations of the cropped 3D dataset (e.g., the volume of interest) representing a tumor of the liver. The bottom-right of the display shows the cropped and zoomed 3D image of the liver (e.g., the tumor of the liver), and the top-left, top-right, and bottom-left of the display show cropped and zoomed 2D images (e.g., 2D slices) of the liver. The cropped and zoomed 2D images and the cropped and zoomed 3D image of the liver may be from the same directions relative to the liver as the 2D images and the 3D image originally displayed at the workstation (e.g., before the 3D data was scaled in act 208 and cropped in act 212), respectively (see FIG. 3). The images are zoomed so that the smaller area or volume of the cropped volume of interest is displayed in a same area on the display.

In act 224, the processor may optionally apply post-processing to the volume of interest (e.g., the cropped 3D data). The processor may automatically apply post-processing to the volume of interest, or the processor may require an input from the user input device before the processor applies post-processing to the volume of interest. In one embodiment, the processor may reconstruct the volume of interest (e.g., the cropped 3D data) in higher resolution. This may improve the image quality and, therefore, the diagnostic value. Any number of image reconstruction methods including, for example, iterative reconstructions and/or filtered back projection may be used. The time required for reconstruction may be decreased compared to the prior art due to the fact that only the volume interest (e.g., compared to all of the 3D data) is reconstructed. Accordingly, the reconstruction includes the processing of fewer data points (e.g., calculations for fewer data points). Alternatively, the processor may reconstruct the volume of interest in a higher resolution in the same amount of time as the prior art reconstructs all of the 3D data in a lesser resolution. Other post-processing may be applied.

After the volume of interest is post-processed, the user may re-enter the review mode at the workstation, and the processor may execute acts 200 to 224 until the user is satisfied with the displayed volume of interest.

By replacing a complex set of 3D image review functions with a simple review workflow including a single review mode and an inspector tool, the user may obtain diagnostic images much faster. Through the reduction of total acts and by simplifying the type of interaction to obtain the diagnostic images, 3D image review may be accessible during interventional procedures. Unlike in radiology, for example, where the user at the workstation may review images long after acquisition, interventional procedures may require the user to view the diagnostic images in the interventional suite and/or the operating room while the patient is still on the patient table. Input devices that may be used in sterile environments such as, for example, joysticks may be used due to the simplicity of the user inputs in the methods of the present embodiments.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for visualizing a volume of interest within a three-dimensional (3D) dataset, the method comprising:
identifying a target point within a volume represented by the 3D dataset;
scaling the 3D dataset around the identified target point, such that the volume of interest is identified;
automatically cropping, by a processor, the 3D dataset to the volume of interest based on the scaling; and
displaying a representation of the cropped 3D dataset.

2. The method of claim 1, further comprising:
receiving a plurality of two-dimensional (2D) datasets from an imaging device;
generating the 3D dataset using the plurality of 2D datasets; and
processing the plurality of 2D datasets and the 3D dataset to generate a plurality of 2D images and a 3D image, respectively.

3. The method of claim 2, further comprising displaying a representation of at least a portion of the 3D dataset, the representation of the portion of the 3D dataset comprising at least one 2D image of the plurality of 2D images, the 3D image, or the at least one 2D image and the 3D image,
wherein identifying the target point within the volume represented by the 3D dataset comprises receiving an input from a user input device, the input comprising a selected point within the at least one 2D image or the 3D image.

4. The method of claim 3, wherein the input is a first input, and
wherein scaling the 3D dataset comprises:
increasing or decreasing a zoom factor of the representation of the portion of the 3D dataset based on a second input received from the user input device; and
setting a height of the volume of interest based on the zoom factor and a third input received from the user input device.

5. The method of claim 4, wherein scaling the 3D dataset comprises scaling the volume of interest such that the width and the length of the volume of interest are equal to the set height.

6. The method of claim 5, wherein the identified target point is a first target point, and
wherein the method further comprises:
setting a center point of the cropped 3D dataset as a second target point; and
scaling the cropped 3D dataset around the second target point.

7. The method of claim 1, further comprising automatically reconstructing the cropped 3D dataset in a higher resolution.

8. The method of claim 2, wherein automatically cropping the 3D dataset comprises automatically cropping the plurality of 2D images and the 3D image to the volume of interest based on the scaling.

9. A system for visualizing a region of interest within a dataset, the system comprising:
an input operable to receive a first input, a second input, and a third input from a user input device; and
a processor operatively connected to the input, the processor being configured to:
identify a target point within a volume represented by the dataset based on the first input;
scale the dataset around the identified target point based on the second input and the third input, such that the region of interest is identified; and
crop the dataset to the region of interest based on the scaling.

10. The system of claim 9, further comprising a display operatively connected to the processor,
wherein the input is further operable to receive a plurality of two dimensional (2D) datasets from an imaging device, at least a subset of 2D datasets of the plurality of 2D datasets at least partially representing the region of interest,
wherein the processor is configured to process the plurality of 2D datasets to generate a plurality of 2D images and a three dimensional (3D) image of the region of interest, and
wherein the display is configured to display a representation of at least a portion of the dataset before the first input is received, the representation of the portion of the dataset comprising at least one 2D image of the plurality of 2D images, the 3D image, or the at least one 2D image and the 3D image, and display a representation of the cropped dataset.

11. The system of claim 10, wherein the user input device comprises a moveable joystick with a depressible button.

12. The system of claim 11, wherein the first input and the third input comprise data representing depression of the button, and the second input comprises data representing movement of the joystick.

13. The system of claim 12, wherein the processor is configured to:
change a zoom factor of the representation of the portion of the dataset based on the second input; and
set a height, a length, and a width of the region of interest based on the changed zoom factor and the third input.

14. The system of claim 9, wherein the imaging device comprises a computed tomography (CT) device, a magnetic resonance (MR) device, a 3D rotational angiography (3DRA) device, or a 3D ultrasound imaging device.

15. In a non-transitory computer-readable storage medium that stores instructions executable by one or more processors to visualize a volume of interest within a three-dimensional (3D) dataset, the instructions comprising:
displaying a representation of at least a portion of the 3D dataset, the representation of at least the portion of the 3D dataset comprising at least one two dimensional (2D) image, a 3D image, or the at least one 2D image and the 3D image;
identifying a target point relative to at least part of the representation based on an input from a user input device, the input comprising a selected point within the displayed representation of at least the portion of the 3D dataset;
scaling around the identified target point, such that the volume of interest is identified;
cropping the 3D dataset to the volume of interest based on the scaling; and
displaying a representation of the cropped 3D dataset.

16. The non-transitory computer-readable storage medium of claim 15, wherein the instructions further comprise:
receiving a plurality of two-dimensional (2D) datasets from an imaging device;
generating the 3D dataset using the plurality of 2D datasets; and
processing the plurality of 2D datasets and the 3D datasets to generate a plurality of 2D images and the 3D image, respectively, the plurality of 2D images comprising the at least one 2D image.

17. The non-transitory computer-readable storage medium of claim 16, wherein cropping the 3D dataset comprises automatically cropping the 3D dataset in response to the scaling.

18. The non-transitory computer-readable storage medium of claim 17, wherein automatically cropping the 3D dataset comprises automatically cropping the plurality of 2D images and the 3D image to the volume of interest based on the scaling.

19. The non-transitory computer-readable storage-medium of claim 15, wherein the input is a first input, and
wherein the scaling comprises:
changing a zoom factor of a 2D image of the at least one 2D image or the 3D image of the displayed representation based on a second input received from the user input device;
setting a height of the volume of interest based on a third input received from the user input device; and
setting a width and a length of the volume of interest to be equal to the set height.

20. The non-transitory computer-readable storage-medium of claim 15, wherein the instructions further comprise automatically reconstructing the cropped 3D dataset in a higher resolution in response to the cropping.
